(19) United States
(12) Patent Application Publication
(10) Pub. No.: US 2012/0066649 A1
(43) Pub. Date: Mar. 15, 2012

(54) DATA ANALYSIS AND TARGET VISUALIZATION REPORTING TOOL

(75) Inventors: Michael Rashed, Wentzville, MO (US); Jeff Till, St. Charles, MO (US); Paul Wilhite, St. Peters, MO (US); Blaine Ambruster, Wentzville, MO (US); Aaron Miramontes, Temecula, CA (US)

(73) Assignee: Millipore Corporation, Billerica, MA (US)

(21) Appl. No.: 13/181,224

(22) Filed: Jul. 12, 2011

Related U.S. Application Data
(60) Provisional application No. 61/399,465, filed on Jul. 12, 2010.

(51) Int. Cl. G06F 3/048

(52) U.S. Cl. 715/854

(57) ABSTRACT

A web based customizable data analysis and visualization tool for providing target profiling services having a system, method, and computer software and reporting tool for processing data. The web based system maintains a first kinome profiling services database and a second GPCR profiling services database. The web based system, upon receiving appropriate operator commands, automatically processes either from the kinome profiling services database and/or GPCR profiling services database, or through a user's data provided in a supplied template, and provides a visual map of the results against a kinome or GPCRome, which show the familial relationships among kinases and GPCRs. respectively. The processing automatically performed by the web based system relates to (but is not limited to) kinome target profiling mapping. GPCRome target profiling mapping, document mapping and production, protein names and/or gene symbol aliases, target descriptions, gene and/or protein related content, target product, and a data navigator. Other web based functions and capabilities include the ability to utilize targetome maps and the like, to visualize data generated by the system.

### CROSS REFERENCE TO RELATED APPLICATIONS

The present application claims the benefit of priority of U.S. Provisional Patent Application No. 61/399,465, filed on Jul. 12, 2010. the entire content of which is incorporated by reference herein in its entirety.

### BACKGROUND OF THE INVENTION

1. Field of the Invention

The present invention generally relates to tools for data analysis. processing and reporting. More particularly the invention relates to interactive tools for processing and visualizing kinase profiling data and GPCR profiling data on targetome maps, particularly useful in drug discovery and development. These tools include software applications having diverse capabilities for data presentation and processing.

2. Technical Background

There is a need in drug discovery and development for enhanced tools to visualize kinase profiles and GPCR (G-protein coupled receptor) inhibitor profiles against test compounds and small molecules. There is also for services which allow researchers to learn about the specificities of their lead compounds or other chemical entities using a panel comprised of hundreds of kinases and GPCRs where such data specificity can aid in the design of more potent and targeted compounds to create and develop successful drugs.

### SUMMARY OF THE INVENTION

In response to the above needs and problems associated with drug discovery and development for adequate tools to help visualize kinase profiles and GPCR (G-protein coupled receptor) inhibitor profiles, the present invention overcomes the challenges by providing a data analysis and visualization-tool (hereinafter, also referred to simply as “tool”)

The present invention encompasses a fully customizable data analysis and visualization tool, that, by way of example only. can used in drug discovery and development, that provides an intuitive interface having customizable functions, as well as the flexibility to view compounds, targets and data ranges, including providing a visualized kinase profile and GPCR inhibitor profiler data on targetome maps by providing a multi-dimensional view and analysis of data, rather than a simple list of activity values, and which allows researchers to set their own parameters for data limits, sizing, colors and targets, among many other variables, and provides flexibility to view compounds, targets and data ranges of interest to a researcher by capturing images needed to develop presentations, helping you more quickly and confidently communicate and advance to the next steps in your drug discovery strategy.

In certain embodiments, the invention provides a drug discovery and development services portal that enables users to access the customizable data analysis and visualization tool,

In certain embodiments, the invention provides tools to securely load previously obtained KinaseProfiler, GPCRProfiler or AllostericProfiler service data.

In still other embodiments, the invention provides tools to map data onto interactive kinome and GPCRome diagrams

In certain embodiments, the invention provides tools to visualize % inhibition, % activity and other data correlated with submitted compounds

In yet other embodiments the invention provides tools to customize normalization and display options.

In certain embodiments, the invention provides tools to save and/or print generated mapped date.

In still other embodiments, the invention provides tools to compare activities of up to four (4) compounds at once.

Another aspect of the invention is providing the ability to customize display options through the choice of activity/inhibition and data range, number of colors, and indicator size.

Another aspect of the invention is providing visualized depiction of multiple compounds simultaneously to allow quick comparison of relative activities

Another aspect of the invention is providing the ability to choose which targets and variants (mutant, species) to display, where more than one target is mapped to the same location on the diagram

Another aspect of the invention is providing the ability to upload internal data via template to compare with stored database provided results

Another aspect of the invention is providing the ability to save and download presentation-quality images.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

Additional features and advantages of the invention will be set forth in the detailed description which follows. Many modifications and variations of this invention can be made without departing from its spirit and scope, as will be apparent to those skilled in the art. It is to be understood that the foregoing general description and the following detailed description, the claims, as well as the appended drawings are exemplary and explanatory only, and are intended to provide an explanation of various embodiments of the present teachings. The specific embodiments described herein are offered by way of example only and are not meant to be limiting in any way.

The accompanying drawings, which are incorporated in and constitute a part of this specification, illustrate the presently contemplated embodiments of the invention and, together with the description, serve to explain the principles of the invention.

### BRIEF DESCRIPTION OF THE DRAWINGS

FIG. 1 is a kinase profiler data analysis targetome according to an embodimemnt of the invention;

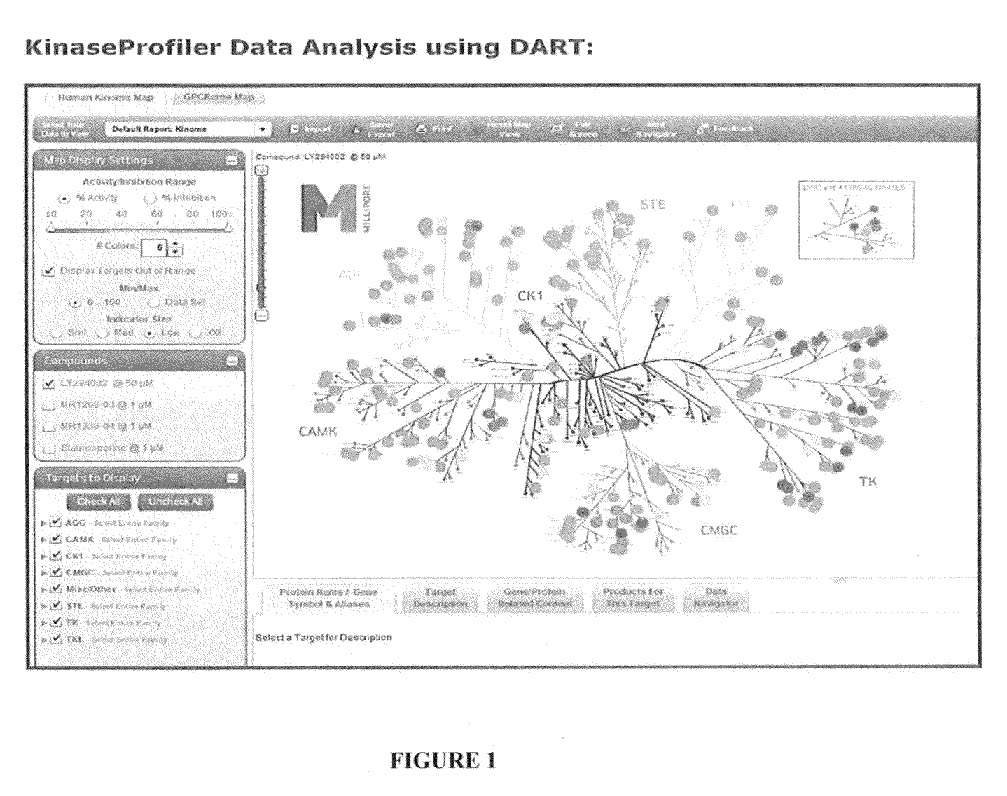

FIG. 2 is a G-protein coupled receptor (GPCR) profiler data analysis targetome according to an embodiment of the invention;

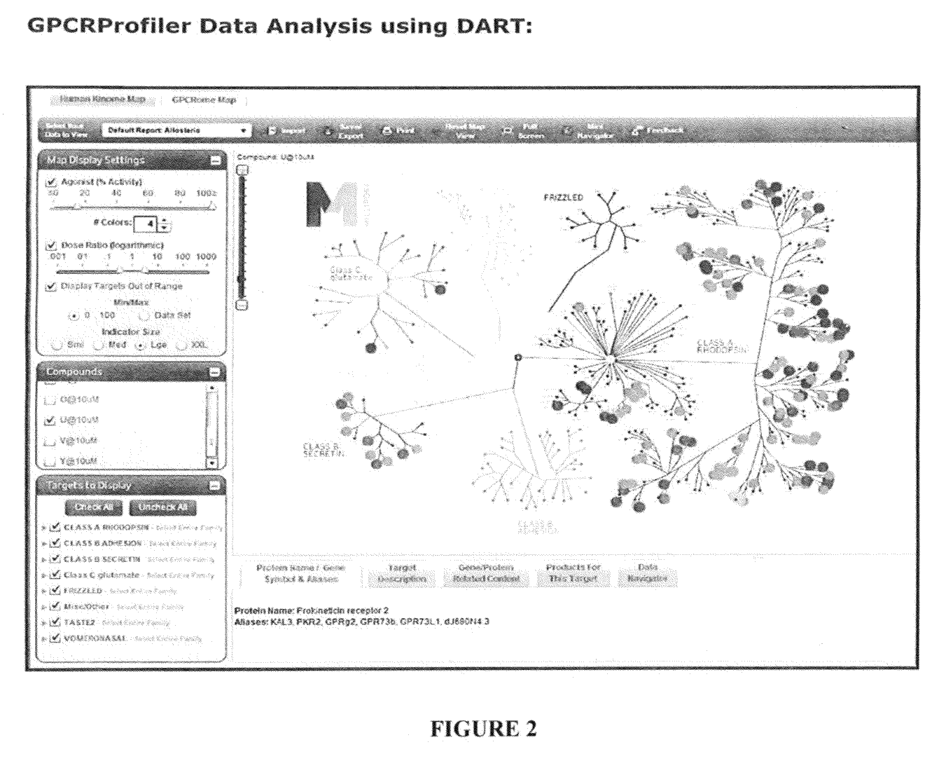

FIG. 3 is a view of multiple adjustable display parameters according to an embodiment of the invention;

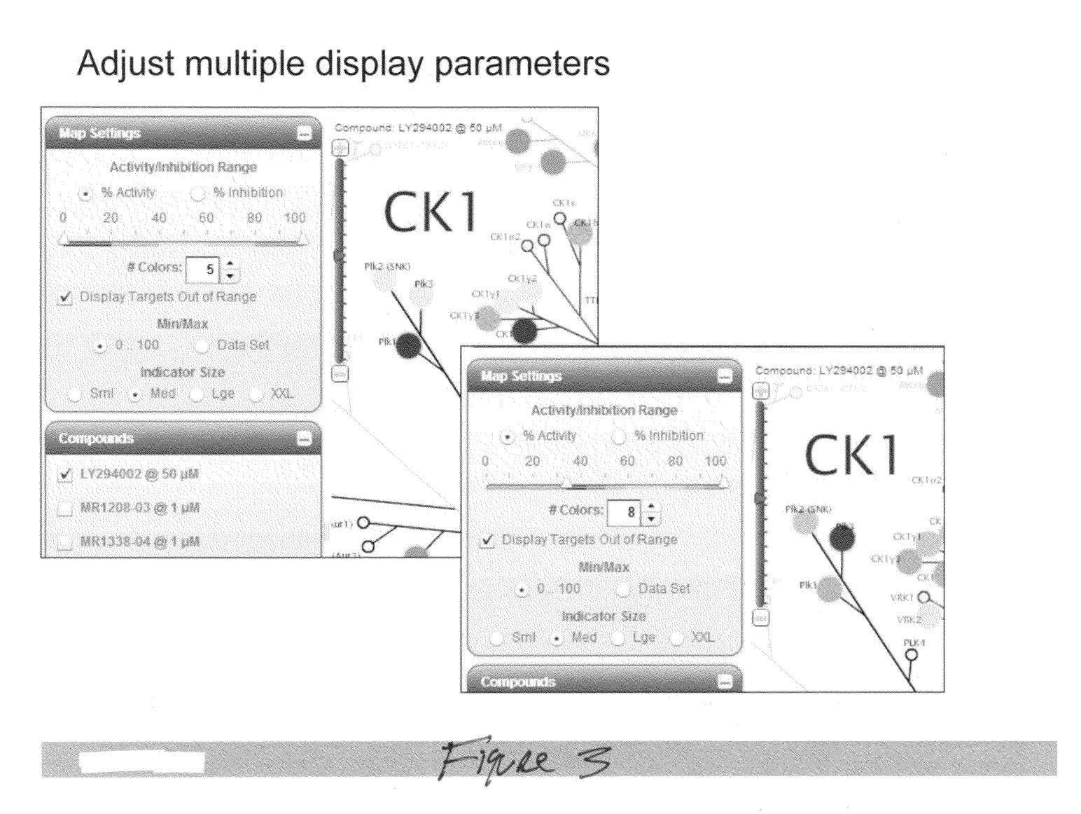

FIG. 4 is a view of comparing multiple compounds accordingly according to an embodiment of the invention; and

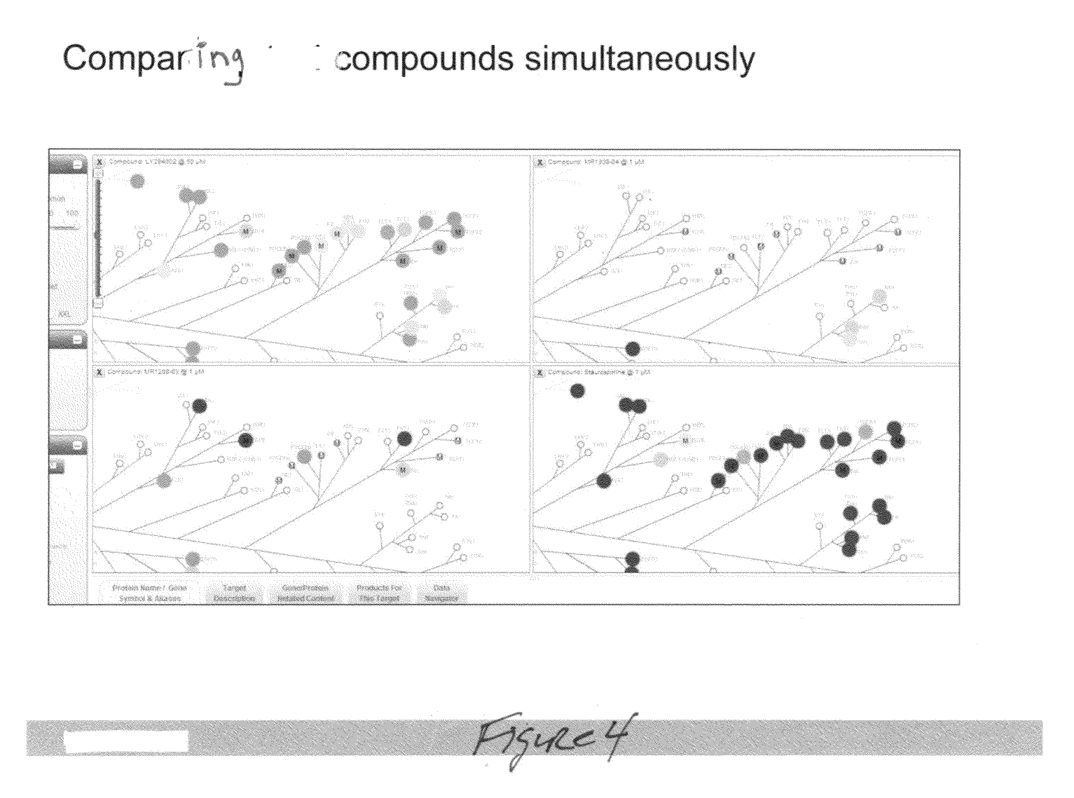

FIG. 5 is a view of data and related content available below a targetome map according to an embodiment of the invention.

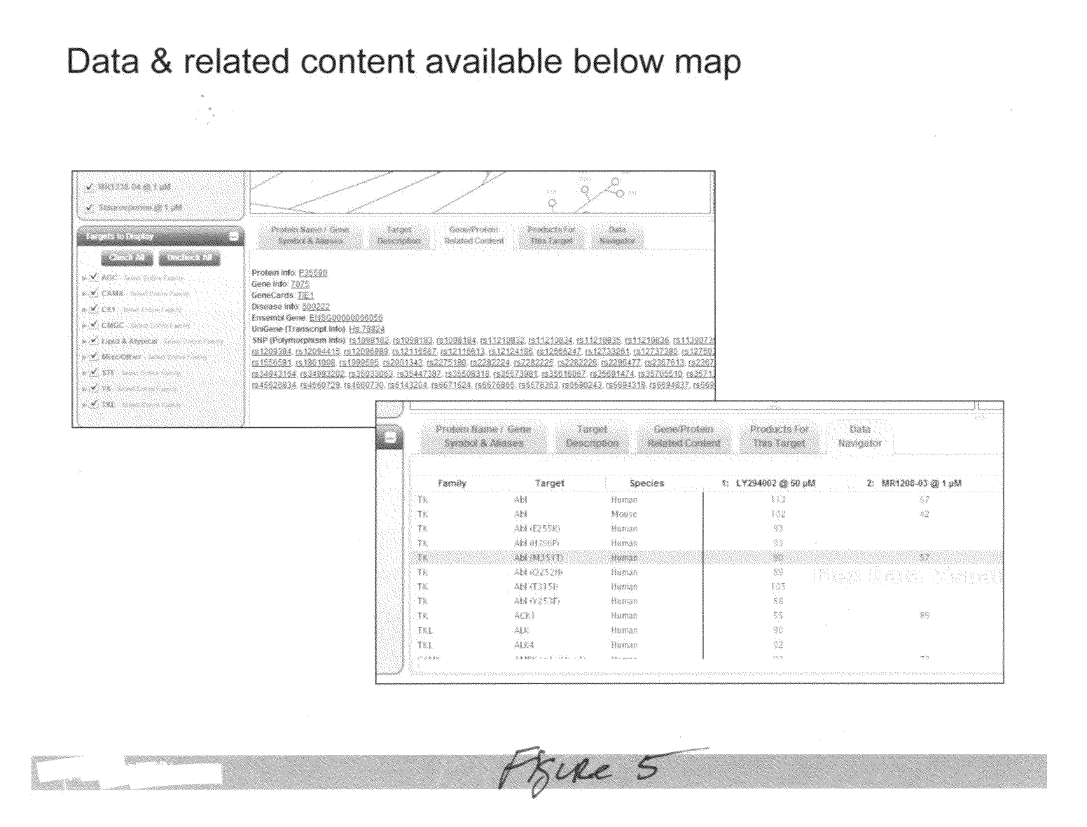

### DETAILED DESCRIPTION OF THE PREFERRED EMBODIMENTS

All publications, patents and patent applications cited herein, whether supra or infra, are hereby incorporated by reference in their entirety to the same extent as if each individual publication, patent or patent application was specifically and individually indicated to be incorporated by reference.

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about”.

Accordingly, unless indicated to the contrary. the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

A system, method, and computer program product and reporting tool for processing data are described herein. The system maintains a first kinome profiling services database and a second GPCR profiling services database. The system, upon receiving appropriate operator commands, automatically processes either from the kinome profiling services database and/or GPCR profiling services database, or through a user's data provided in a supplied template, and provides a visual map of the results against a kinome or GPCRome, which show the familial relationships among kinases and GPCRs, respectively. The processing automatically performed by the system relates to (but is not limited to) kinome target profiling mapping, GPCRome target profiling mapping, document mapping and production, protein names and/or gene symbol aliases, target descriptions, gene and/or protein related content, target product, and a data navigator. Other functions and capabilities are also covered, including the ability to utilize targetome maps and the like to visualize data generated by the system, method, and computer program product.

This tool allows customers to import data, either from a profiling services directly or through a template, and visualize the results mapped against kinome or GPCRome diagrams, which show the familial relationships among kinases and GPCRs (G-protein coupled receptors), respectively.

Through color-coded indicators, the display gives unique insights into the specificity or promiscuity of inhibitory activity of customer compounds against panels of kinases or GPCRs by converting summarized data of activity levels to a visual representation. The tool allows for extensive customization via adjustments of visualized activity ranges, number of indicator colors, indicator size, and ability to view any subset of targets and up to four compounds simultaneously. Through information tabs below the map display, the tool also provides extensive background information on selected targets, including protein database links, related database products, and a Data Navigator tab that can steer the map view to selected targets and reorganize profiling data to facilitate easier searches.

Kinase Profile Data Analysis provides:

A unique tool to visualize services data on targetome maps.

Visualize kinase protein and GPCR profiler data on targetome maps.

Ability to choose activity/inhibition and data range, number of colors, indicator

Size.

View up to four compounds simultaneously (quad view).

Choose which targets and variants (mutant, species) to display where multiples available.

Upload internal data via template to compare with database results.

Save and download presentation-quality images.

Data reports linked to targetome portal.

Multi-color, with customer choice of limits.

Customize views and data display limits

Ability to view data for uploaded in-house data through template

Combine online ordering for all services

Targetome with links to products and gene info, as well as data visualization

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

### Example 1

An example of how to access and use the data analysis and visualization tools and software application for visualizing GPCR (G-protein coupled receptors), as well as kinase protein activity

Step 1. Data Analysis and Visualization Tool User's Account

To access the tool, a user first needs to sign up and create drug discovery services portal account, or sign into a user's existing account using the same portal;

Step 2. Data Analysis and Visualization Tool User Logins

Once a user's account is active (the user can receive a confirmation e-mail, text message, and the like to complete activation), the user logins into so to launch and access data analysis and visualization tool, receive user's data through the portal or request new services such as by using a “Launch” button.

Step 3. Data Analysis and Visualization Tool Importing data

To begin using the data analysis and visualization tool's features, the user's first step is to upload the user's profiling data. The user can choose to use the sample data reports available in a drop down menu at the top of the screen, or upload the user's own kinase profiler, GPCR profiler or GPCR allosteric profile data (depending on which map the user are viewing) by using an “Import Dialog” button next to the drop-down menu.

To import kinase profiler data through the import dialog, the user selects a summary report from the users desktop or online. If a user's chosen project contains both types of kinase reports (i.e., protein kinase reports and lipid kinase reports), they will typically be combined into one report for upload into the data analysis and visualization tool.

A user's in-house profiling data can also be imported for viewing by data analysis and visualization tool, by downloading and filling in a template that are available in the import dialog. GPCR profiler and GPCR allosteric profiler data should be formatted in the respective template.

The user can manipulate the kinome map by clicking and dragging it to your preferred position, and zoom in or out using the slider bar or Ctrl+mouse wheel. Once the user's data is imported, the user selects one of the compounds in the list adjacent the kinome map.

Step 4. Data Analysis and Visualization Tool Display Settings

i) The user can view the color range by % Activity or % Inhibition (for example in both cases green can correspond to lower inhibition, and red can correspond to being maximum inhibition.

ii) Data limits: Adjust sliders on colored bar to set limits on the data to be viewed in map

iii) Data outside set limits will appear as grey indicators, or not at all. depending on the user's selection.

iv) The user can choose from a number of colors to give you the level of differentiation the user prefers.

v) Min/Max: Keep the data limits at 0-100 or set them based on the actual data in the user's report. Combining this setting with data limits and numbers of colors enables in the user's report to view, for example, kinase activating effects of compounds.

vi.) Indicator size. the user can adjust size to produce the best image for the desired level of magnification

Step 5 Data Analysis and Visualization Tool Compound Display

All compounds in the selected/imported data report are available for selection and display on the map. Up to four (4) compounds may selected at once for side-side comparisons.

Step 6. Data Analysis and Visualization Tool Multiple Variant Viewer

“M” indicators (e.g., purple) designate targets for which different variants (mutants, species, etc.) were profiled. By clicking on the “M” the user opens a listing of variants and activity values. Selecting one variant will change the indicator from purple to the corresponding color for the data value.

Step 7. Data Analysis and Visualization Tool GPCRome Map

The user can manipulate the map by clicking and dragging it to the user's preferred position, and zoom in or out using a slider bar or Ctrl+mouse wheel, or other methods. Once your data is imported, the user selects one of the compounds in the adjacent the map.

The map can contain colored indicators that correspond to the agonist (% activity) or antagonist (% Inhibition) recorded for that target against the selected compounds

The map can contain colored indicators correspond to the agonist (% activity)

or dose ratio (logarithmic) recorded for that target against the selected compound(s).

Step 8. Data Analysis and Visualization Tool Customizable Map Display Settings

GPCT profiler function: the user can view the color ranges by either agonist (%

activity), antagonist (% Inhibition), or both;

GPCR allosteric profiler function: the user can view the color ranges by either agonist (% activity), dose ratio (logarithmic), or both;

Data limits function: the user can adjust sliders on colored bars to set limits on the data to be viewed in map Data outside set limits will appear as grey indicators, or not at all, depending on your selection (i.e., the user can view a “Display Targets Out of Range” checkbox in this section) The User can choose the number of colors to give you the level of differentiation you prefer

Min/Max function: the user can keep the data limits at 0-100 or set them based on the actual data in your report. Combining this setting with data limits and numbers of colors allows you to view, for example, GPCR potentiating effects of compounds

Indicator size: the user can adjust the size to produce the best image for the desired level of magnification

Step 10. Data Analysis and Visualization Tool Target Information & Data

The protein Name/gene Symbol & Aliases, Target Description, and gene/protein Related Content tabs display related bioinformatics data, additional information, and links to reference sites associated with a user selected target.

The products for this target tab displays available product types associated with a selected target. Clicking on product type link will open an online product catalog and the like.

The data navigator tab displays all targets and data associated with the selected/imported report. Clicking on any target row will select the associated individual target and will navigate to the same target in the targets to display list in the map on the selected target, and briefly highlight the target node.

Step 11. Toolbar

i) a user selects their data view displays data reports that have been imported into the tool and are available for visualization;

ii) import function opens a window enabling a user to import data reports into the tool;

iii) save/export function opens a window enabling a user to save selected data and map views to a local environment;

iv) print function opens a window displaying a print preview, from which a user may print their map view;

v.) reset map function view immediately returns the map to its

default state.

vi.) full screen function displays the map view only in full screen mode. Map settings and target information can still be accessed by dragging menus, respectively.

vii.) mini navigator function opens a window with a min-map that enables the user to quickly navigate the entire map.

viii.) color legend function displays colors and data ranges used on the map based on the map display settings.

What is claimed is:

1. A web based customizable data analysis and visualization tool system for providing target profiling services including:
a reporting tool for processing data;
computer software;
a first kinome profiling services database;
a second GPCR profiling services database
a user's data, and
a visual map of the results against a kinome or GPCRome, which show the familial relationships among kinases and GPCRs, respectively.

2. The system of claim 1 wherein the processing performed by the system relates to kinome target profiling mapping. GPCRome target profiling mapping, document mapping and production, protein names and/or gene symbol aliases, target descriptions, gene and/or protein related content, target product, and a data navigator.

3. The system of claim 1 further comprising a targetome map.
